(19) United States
(12) Patent Application Publication
(10) Pub. No.: US 2007/0247706 A1
(43) Pub. Date: Oct. 25, 2007

(54) Interpupillary Viewpoints Distance Minimizer (IVDM)

(76) Inventor: George Mataban Calm, Fontana, CA (US)

Correspondence Address: George M. Calm, 13367 Harper Pl, Fontana, CA, 92336, US

(21) Appl. No.: 11/560,865

(22) Filed: Nov. 17, 2006

Related U.S. Application Data
(60) Provisional application No. 60/745,351, filed on Apr. 21, 2006.

(51) Int. Cl. G02B 23/00

(52) U.S. Cl. 359/412; 359/407

(57) ABSTRACT

A viewing device for minimizing the distance between interpupillary viewpoints of the left and right eyes to effect biocular viewing or minimized viewpoints viewing by partially reflecting the view of one eye to the other eye or by partially reflecting the view near one eye to the other eye through a series of reflectors starting with the flat semi-silvered mirror (20) that partially reflects light towards the roof mirror (22 and 26) and concave mirror (24) combination that reflects an erect and focused image that is then received by the entry parabolic mirror (28) that collects light about the center of the converging mirror and reflects it towards the facing exit parabolic mirror (30) and finally reflecting and converging the light to the pupil of the other eye.

### CROSS-REFERENCE TO RELATED APPLICATIONS:

This application claims the benefit of provisional patent application Ser. No. 60/745,351, filed 2006 Apr. 21 by the present inventor.

### FEDERALLY SPONSORED RESEARCH

None.

### SEQUENCE LISTING

None.

### BACKGROUND OF THE INVENTION

1. Field of Invention

This invention relates to bi-ocular viewing systems or devices, specifically to an interpupillary viewpoints distance minimizer.

2. Prior Art

Two-dimensional pictures from various display systems or printed media are viewed usually with naked eyes binocularly or using both eyes unaided. However, viewing these pictures with naked eyes enables the viewer to perceive the flatness of the display or printed surface and the illusion of depth from these pictures are easily defeated. When the illusion of depth in the picture we view is less, the picture will also look less real and the excitement, the interest, and the entertainment it should bring is diminished.

Monoscopic viewing from a single viewpoint monocularly using one eye is advantageous in viewing two-dimensional display systems or printed media than binocular viewing or viewing with unaided eyes. Biocular viewing or viewing with both eyes monoscopically, however, is even more advantageous than monocular viewing because while the former uses both eyes, the latter use just one eye in viewing.

A viewer can view two-dimensional display systems monoscopically by merely closing or covering one eye. However, a person used to view with two eyes will sense burden on the open eye, will sense obstruction on the covered eye, or will experience fatigue on the open or closed eye. It is almost effortless to keep both eyes closed or open at the same time but it would take a certain amount of effort to keep one eye open and the other eye closed at the same time.

Devices of present use with bi-ocular viewing means are associated with magnification to view very far or very small objects. Most two-dimensional display systems, however, such as televisions, computer monitors, movie theater display systems, and printed media does not need magnification at their normal viewing distance ranges.

There are many cases that we encounter problems on having to peer in to small openings that are less wide than the interpupillary distance of our eyes. This makes it difficult to use both unaided eyes to view objects behind such small openings. An example is a dentist working on a patient's mouth. Work is much easier and safer if we use both our eyes in our work or activities at all times.

Bi-ocular viewing devices of current use need more complex optical components or complex display devices in order to achieve the same large view that can cover most two-dimensional display systems and media.

### BACKGROUND OF THE INVENTION—OBJECTS AND ADVANTAGES

Accordingly, several objects and advantages of the present invention are:
a) to provide a viewing system or device that will increase depth illusion from pictures on two-dimensional display systems and other two-dimensional media thereby enhancing learning and entertainment.
b) to provide a viewing system or device that will give the user the comfort of viewing monoscopically with both eyes freeing the eyes from eye fatigue longer than with unaided eyes.
c) to provide a viewing system or device that can achieve a view angle that can cover most two-dimensional display systems at their normal viewing distance ranges.
d) to provide a viewing system or device that will allow a user, using both eyes, to view objects behind small openings that are less wide than the interpupillary distance of his or her eyes.
e) to provide a viewing system or device that will increase the ability of the user to observe fast moving objects that comes in the view of the viewing device.

Other objects and advantages of the present invention are:
f) to provide a viewing device that will be used in conjunction with various magnifying systems or means for viewing very small or very far objects or scenes.
g) to provide a viewing device that can be mounted to the head of the user with various head mounting means.
h) to provide a viewing device that will increase the viewer's realistic scene perception on live performances by blending the live performance with the two-dimensional background into one realistic view.
i) To provide a bi-ocular viewing device that have lesser number of components that covers the view of most two-dimensional display systems and media at their normal viewing distances.

Further objects and advantages of my present invention will become apparent from consideration of the drawings and ensuing description.

### SUMMARY

In accordance with the present invention, the interpupillary viewpoints distance minimizer or IVDM, have a flat semi-reflecting surface that allows some image light to pass through towards one eye and reflects the rest towards a combination of roof reflector and a converging reflector that produces an erect image at the other end, that is in turn reflected by two facing parabolic mirrors with common axis towards the pupil of the other eye producing bi-ocular view.

### DRAWINGS—FIGURES

FIG. 1 is a view from the upper right side of the IVDM.

FIG. 2 is a plan view of the IVDM.

FIG. 3 is section 3-3 in FIG. 2 plan showing how erect and focused image is produced.

FIG. 4 is a plan showing how a view to infinity by one eye is transferred to the other eye.

FIG. 5A and 5B shows movement of parts for adjustment to various interpupillary viewpoints distance.

FIG. 6A and 6B shows movement of parts for adjustment to various interpupillary distances of users.

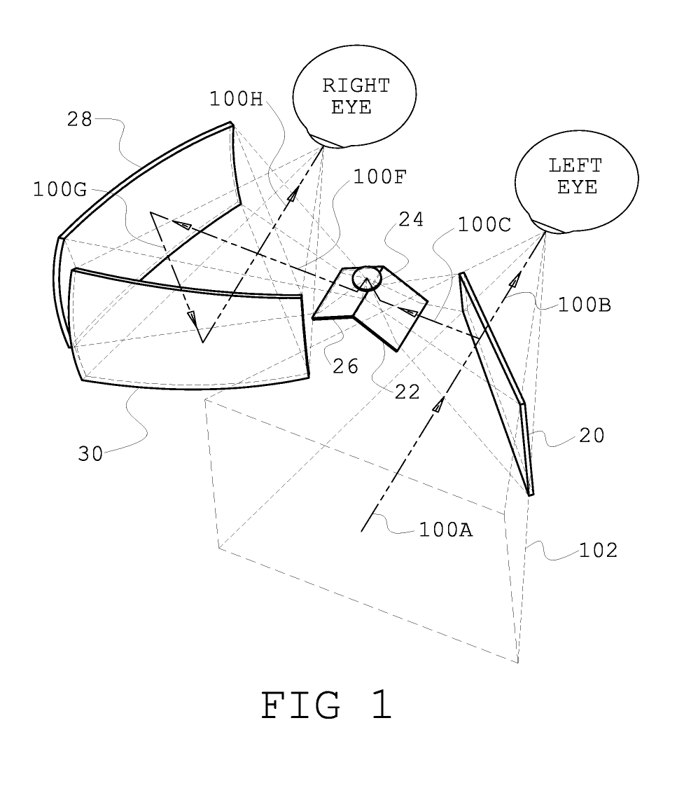

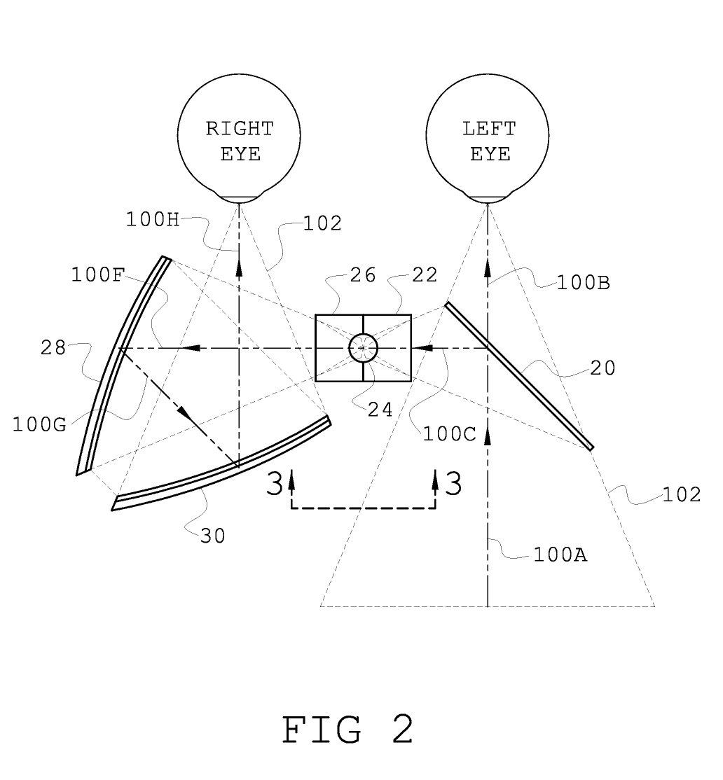

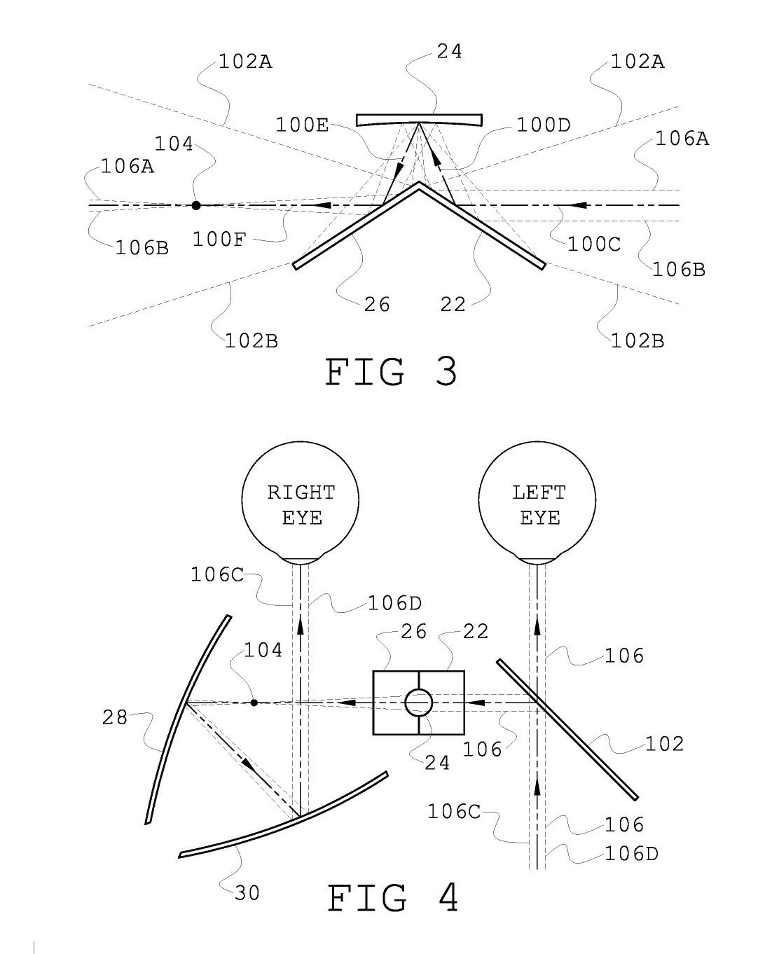

DRAWINGS-REFERENCE NUMERALS

| | |
|---|---|
| 20 | flat semi-silvered mirror |
| 22 | roof entry mirror |
| 24 | converging mirror |
| 26 | roof exit mirror |
| 28 | entry parabolic mirror |
| 30 | exit parabolic mirror |
| 100A to 100H | view axis and beam of light with arrows |
| | representing the direction of light |
| 102 | view coverage outline |
| 102A | entry and exit beam at the roof |
| | mirror/converging lens from top of the |
| | image being viewed |
| 102B | entry and exit beam at the roof |
| | mirror/converging lens from bottom of the |
| | image being viewed |
| 104 | converging mirror focal point represented |
| | by a big dot |
| 106 | parallel components of light representing |
| | view to infinity |
| 106A and 106B | top and bottom beams respectively |
| | from view |
| 106C and 106D | left and right beams respectively |
| | from view |

### DETAILED DESCRIPTION—PREFERRED EMBODIMENT

The IVDM has a thin, flat, semi-silvered mirror (20) that is made up of dimensionally stable transparent material. The amount of silvering on the mirror (20) is based on the balance of light that the left and right eye receives. The mirror (20) is angled to reflect some light coming toward the direction of the left eye toward the roof entry mirror (22).

The roof mirror is a pair of flat mirrors that is angled like a roof, the entry (22) and exit (26) mirrors with the reflecting sides facing the converging mirror (24). The roof entry mirror (22) is angled to reflect the view axis towards the center of the converging mirror (24). The roof exit mirror is angled to receive view axis from center of converging mirror (24) and reflect the view axis towards the entry parabolic mirror (28). The roof mirror is made up of dimensionally stable material.

The converging mirror (24) is also made up of materials used on the roof mirror (22 and 26). The focal point (104) of the converging mirror (24) can be calculated graphically by drawing two parallel lines from the right pupil of the right eye along the view axis until the two lines merge after being graphically reflected by the two parabolic mirrors (28 and 30). The length along the view axis from the merging point of the two parallel lines to the center of the concave mirror is about the focal length of the converging mirror (24).

The entry parabolic mirror (28) and the exit parabolic mirror (30) are made up of the same materials as the roof mirror (22 and 26) and the concave mirror (24). The two parabolic mirrors (28 and 30) have common parabolic axis. Their reflecting surfaces can be constructed by revolving two parabolic profiles about their common axis. The focus of the entry parabolic mirror (28) is the center of the converging mirror (24). The focus of the exit parabolic mirror is the position or location of the pupil of the right eye.

### DETAILED DESCRIPTION—OPERATION OF INVENTION

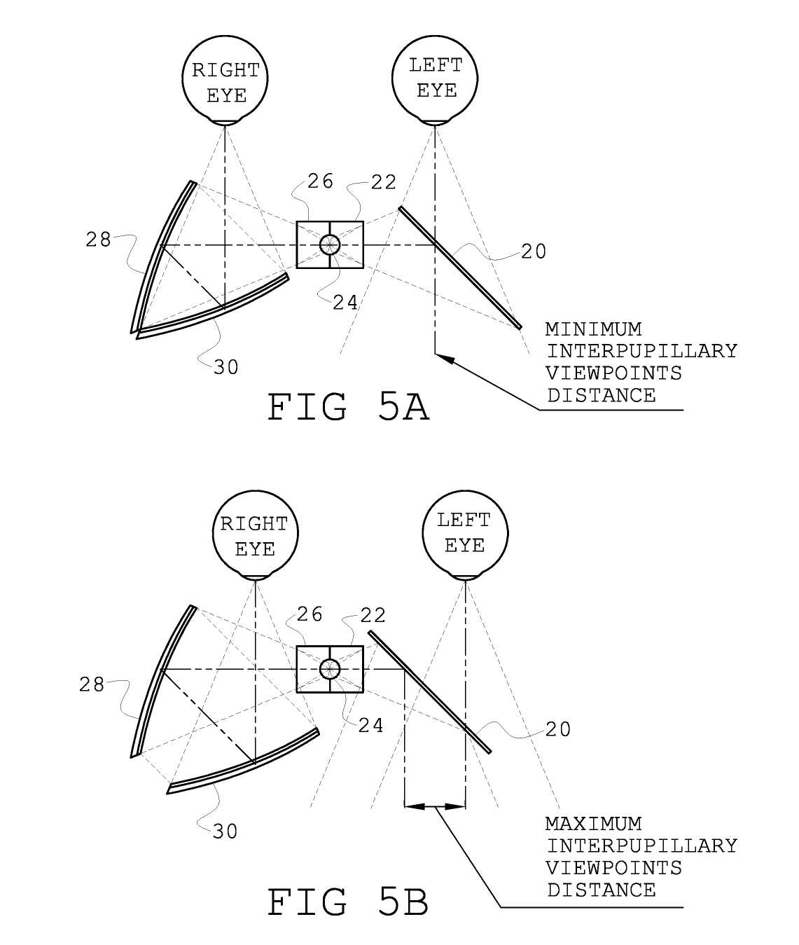

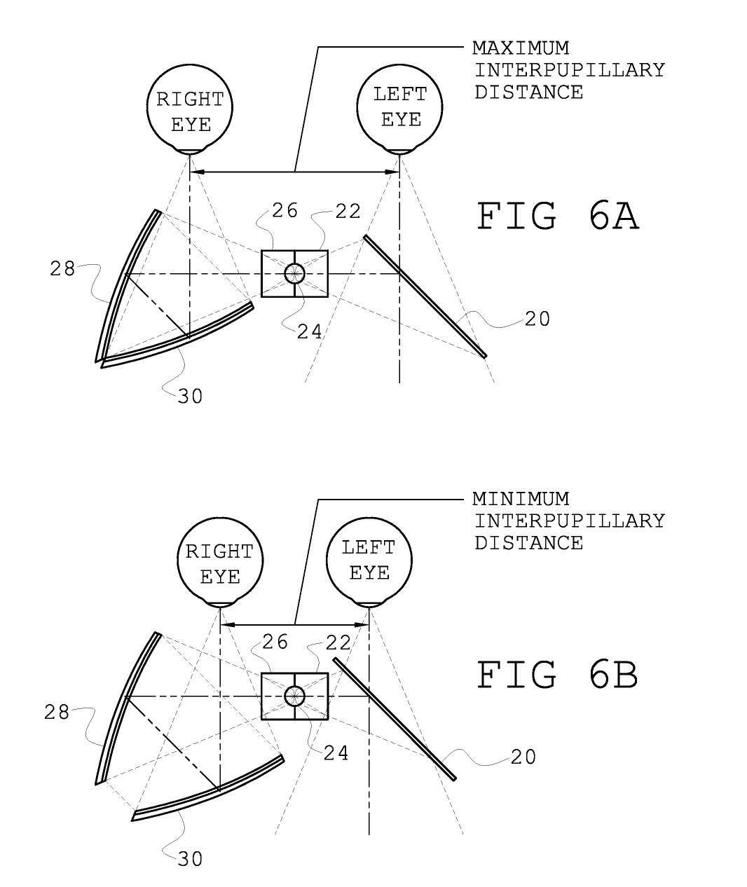

Light (100A) from the object or scene being viewed first reaches the semi-silvered mirror (20). The flat semi-silvered mirror (20) allows some light to pass through (100B) while reflecting the rest (100C). Light that passes through (100B) the semi-silvered mirror (20) reaches the pupil of the left eye and produces the left image. The reflected light (100C) reaches the roof entry mirror (22). The roof entry mirror (22) then reflects the light (100D) towards and with the view axis aimed at the center of the converging mirror (24). The converging mirror collects all reflected light coming from the view coverage (102) or scene at about its center. The converging mirror acts as the virtual pupil of the right eye. The converging mirror receives an inverted image from the roof entry mirror (22) then reflects (100E) an erect image towards the roof exit mirror (26). The light (100F) is then reflected towards the entry parabolic mirror (28). The center of the converging mirror is the location of the focal point of the entry parabolic mirror (28). Beams of light coming from about the center of the converging mirror (24) that are reflected by the roof exit mirror (26), are reflected by the entry parabolic mirror (28) in parallel beams (100G) toward the exit parabolic mirror (30). Since the focus of the entry parabolic mirror (28) is at the center of the converging mirror (24), no magnification occurs. The exit parabolic mirror (30) then merges the beams of light (100H) towards its focal point at the pupil of the right eye. Parallel components of light (106 and 106A to 106D) with its axis (100C and 100D) hitting the center of the converging mirror (24) will merge at about the focal point (104) of the converging mirror and after being reflected by the parabolic mirrors (28 and 30) will finally be reflected towards the pupil of the right eye with minimized convergence (106C and 106D) producing a clear image. The converging mirror works in conjunction with the two parabolic mirrors to bring clear image to the right eye. Clear image is produced on the right eye that is virtually identical to the one produced on the left eye resulting to bi-ocular monoscopic view. Various interpupillary viewpoints distance settings can be achieved by moving parts (20 and 30) as shown in FIG. 5A and 5B. Various interpupillary distance settings can also be achieved by moving parts (20 and 30) as shown in FIG. 6A and 6B to accommodate various users.

### CONCLUSION, RAMIFICATIONS, AND SCOPE

Thus the reader will see that the bi-ocular viewing device of the invention provides a very advantageous means of viewing two-dimensional pictures so that they closely resemble experience, putting the eyes of the user at the location of the camera lens where the picture was taken. The reader will see that the invention will help students, professionals, and all persons get more learning experience and entertainment from two-dimensional display systems and media. The reader will see that the invention will provide better vision and safety for viewing tasks where monoscopic viewing is more advantageous than stereoscopic viewing.

While my above description contains many specifications, these should not be construed as limitations on the scope of the invention, but rather as an exemplification of one preferred embodiment thereof. Many other variations are possible. For example, the invention can be reversed for right eye viewing. The invention can be printed for advertising purposes. The invention can be head mounted, tripod mounted, hat mounted, visor mounted among other mounting systems and devices. The invention can be mounted with a display system fronting diagonally the inner side of the flat semi-silvered mirror to superimpose with the view. The invention can be mounted with sound system. The invention can be mounted with computer system or multimedia system. The invention can be made adjustable to various interpupillary and viewpoints distances or made with permanent optical settings. The invention can be mounted with magnifying devices for viewing concerts, sports, cosmos and microorganisms among others.

Accordingly, the scope of the invention should be determined not by the embodiment illustrated, but by the appended claims and their legal equivalents.

I claim:

1. A viewing device for minimizing the distance between interpupillary viewpoints of the left and right eyes, comprising:
(a) a transparent material having flat partially reflecting surface with sufficient size for viewing through with one eye that will allow some light to pass through while reflecting the rest,
(b) a roof reflector having two flat reflecting surfaces angled like a roof,
(c) means for reflecting and converging light,
(d) a pair of facing concave parabolic reflecting surfaces with common parabolic axis,
(e) means to support and hold member parts at their respective positions,
whereby said reflectors are positioned and arranged to sequentially reflect the view of one eye to the other eye allowing one eye to view through said flat partially reflecting surface, directly to the object being viewed thereby producing bi-ocular monoscopic view.

2. The viewing device of claim 1 wherein said transparent material having flat partially reflecting surface is composed of material or combination of materials used in optical lenses, mirrors or prisms, partially silvered using means or process of silvering mirrors.

3. The partially reflecting surface of claim 2 wherein said material or combination of materials is in the form of thin, flat, rigid sheet or plate.

4. The partially reflecting surface of claim 2 wherein said material or combination of materials is in the form of thin film supported by a rigid frame.

5. The partially reflecting surface of claim 2 wherein said material or combination of materials is in the form of coupled right angle prisms.

6. The viewing device of claim 1 wherein said roof reflector is composed of the same material or materials of claim 2, full silvered using means or process of silvering mirrors.

7. The roof reflector of claim 6 wherein said material or combination of materials is in the form of a thin, flat, rigid sheet or plate angled like a roof.

8. The roof reflector of claim 6 wherein said material or combination of materials is in the form of two thin, flat, rigid sheets or plates angled like a roof.

9. The roof reflector of claim 6 wherein said material or combination of materials is in the form of prism.

10. The viewing device of claim 1 wherein said means of reflecting and converging light is composed of the same material or materials of claim 2, full silvered using means or process of silvering mirrors.

11. The means of reflecting and converging reflected light of claim 10 wherein said material or combination of materials is in the form of concave mirror.

12. The means of reflecting and converging reflected light of claim 10 wherein said material or combination of materials is in the form of converging lens, fully silvered at the opposite side facing the roof mirror using means or process of silvering mirrors.

13. The viewing device of claim 1 wherein said roof reflector and said means of reflecting and converging light is combined in the form of a prism.

14. The viewing device of claim 1 wherein said pair of facing concave parabolic reflecting surfaces with common parabolic axis is composed of the same material or materials of claim 2, full silvered using means or process of silvering mirrors.

15. The pair of facing concave parabolic reflecting surfaces with common parabolic axis of claim 14 wherein said material or combination of materials is in the form of concave sheet or plate.

16. The pair of facing concave parabolic reflecting surfaces with common parabolic axis of claim 14 wherein said material or combination of materials is in the form of prism.

17. The viewing device of claim 1 wherein said means to support and hold member parts at their respective positions is made up rigid material or combination of materials formed through means of forming, shaping and joining materials.

18. The means to support and hold member parts at their respective positions of claim 17 wherein said rigid material or combination of materials is in the form of enclosure with view paths not blocked for viewing.

19. The means to support and hold member parts at their respective positions of claim 17 wherein said rigid material or combination of materials is in the form of a frame.

20. The means to support and hold member parts at their respective positions of claim 17 wherein said materials or combination or materials is in the form of combination of enclosure and frame.

20. The means to support and hold member parts at their respective positions of claim 17 wherein means of guiding the eyes at the right position is provided.

21. The means to support and hold member parts at their respective positions of claim 17 wherein means of mounting to the head of the user or to a stand or tripod is provided.

22. The means to support and hold member parts at their respective positions of claim 17 wherein moving or mechanical means are provided to facilitate adjustment of interpupillary distance.

23. The means to support and hold member parts at their respective positions of claim 17 wherein moving or mechanical means are provided to facilitate adjustment of interpupillary viewpoints distance.

24. The means to support and hold member parts at their respective positions of claim 17 wherein moving or mechanical means are provided to facilitate adjustment of interpupillary viewpoints distance and the interpupillary distance.

25. The viewing device of claim 1 wherein means of magnifying very far or very small objects is provided.
